(19) United States
(12) Patent Application Publication
(10) Pub. No.: US 2013/0165064 A1
(43) Pub. Date: Jun. 27, 2013

(54) RECEPTION DEVICE AND IMAGE DISPLAY APPARATUS

(71) Applicant: SONY CORPORATION, Tokyo (JP)

(72) Inventors: Katsumi Oishi, Chiba (JP); Kosuke Fujita, Kanagawa (JP)

(73) Assignee: SONY CORPORATION, Tokyo (JP)

(21) Appl. No.: 13/705,809

(22) Filed: Dec. 5, 2012

(30) Foreign Application Priority Data
Dec. 26, 2011 (JP) 2011-283089

(51) Int. Cl. H04B 1/18

(52) U.S. Cl. CPC H04B 1/18
USPC 455/193.1; 375/316

(57) ABSTRACT

A reception device includes first and second antennas that receive the same kind of electric wave; a third antenna that receives a different kind of electric waves from that of the first and the second antennas; an antenna switching switch that switches a first input mode of inputting the electric waves received by the first and second antennas and a second input mode of inputting the electric wave received by the third antenna; a first tuner circuit that receives the electric wave in each of the first and second input modes; and a second tuner circuit that receives the electric wave in the first input mode, wherein diversity reception for the first and second antennas is performed based on the signals output from the first and second tuner circuits in the first input mode, and wherein a signal is output from the first tuner circuit in the second input mode.

### BACKGROUND

The present disclosure relates to a reception device and an image display apparatus, and more particularly, to a technical field of switching input modes of electric waves received by three antennas using an antenna switching switch to reduce a size and a manufacturing cost.

As an image display apparatus having a display such as a television and a mobile terminal device, there is a reception device having a plurality of antennas (for example, Japanese Patent No. 3474763).

The image display apparatus disclosed in Japanese Patent No. 3474763 employs a diversity reception method of selecting an electric wave with a satisfactory reception state from electric waves received by the plurality of antennas, and displaying an image on the display using the electric wave with the satisfactory reception state.

FIG. 4 is a schematic diagram illustrating a configuration of a reception device employing a diversity reception method.

For example, the reception device a includes a first antenna b and a second antenna c which receive the same kind of electric wave, for example, digital waves. The first antenna b and the second antenna c are connected to a first tuner circuit d and a second tuner circuit e, respectively, and the first tuner circuit d and the second tuner circuit e are connected to a demodulation circuit (a digital demodulation device: DMD) f.

In the reception device a, for example, the digital waves (ground waves) received by the first antenna b and the second antenna c are transmitted to the first tuner circuit d and the second tuner circuit e, respectively, and tuning and frequency conversion are performed in the first tuner circuit d and the second tuner circuit e. The demodulation circuit f controls the first tuner circuit d and the second tuner circuit e to perform ordinary diversity reception, displays an image on the display, and outputs a sound, on the basis of optimal digital signals (an image signal and a sound signal) input from the first tuner circuit d or the second tuner circuit e.

In the image display apparatus having the reception device described above, there is a type capable of receiving a different kind of electric waves, for example, a type capable of receiving a digital wave and an analog wave in which a diversity reception method is employed with respect to reception of the digital wave.

FIG. 5 is a schematic diagram illustrating a configuration of a reception device in which the diversity reception method capable of receiving a digital wave and an analog wave is employed with respect to reception of the digital wave.

The reception device g includes a first antenna h and a second antenna i capable of receiving a digital wave, and a third antenna j that receives an analog wave.

The reception device g is provided with a first tuner circuit k and a second tuner circuit 1, an antenna switching switch m is provided on a transmission path to the first tuner circuit k, and an input terminal n is provided on a transmission path to the second tuner circuit 1. The antenna switching switch m is provided with a first input terminal o connected to the first antenna h, and a second input terminal p connected to the third antenna j, and switches the first input terminal o and the second input terminal p.

The first tuner circuit k is connected to a first demodulation circuit (DMD) q, and a second demodulation circuit (an analog demodulation device: AMD) r, and the second tuner circuit 1 is connected to the first demodulation circuit q.

In the reception device g, in a state where the antenna switching switch m can be switched to a connection of the first input terminal o, for example, the digital waves (the ground waves) received by the first antenna h and the second antenna i are transmitted to the first tuner circuit k and the second tuner circuit 1 through the first input terminal o and an input terminal n, respectively, and tuning and frequency conversion are performed in the first tuner circuit k and the second tuner circuit 1. The first demodulation circuit q controls the first tuner circuit k and the second tuner circuit l to perform ordinary diversity reception, displays an image on the display, and outputs a sound, on the basis of digital signals (an image signal and a sound signal) generated by an electric wave with a satisfactory reception state of the first tuner circuit k and the second tuner circuit 1.

Meanwhile, in the reception device g, in a state where the antenna switching switch m can be switched to a connection to the second input terminal p, the analog wave received by the third antenna j is transmitted to the first tuner circuit k through the second input terminal p, the analog signal is input from the first tuner circuit to the second demodulation circuit r, the image is displayed on the display, and the sound is output.

As described above, in the reception device of the type capable of receiving a different kind of electric waves, it is possible to perform the optical image display and sound output by the diversity reception method.

However, in the reception device of the type capable of receiving a different kind of electric waves described above, in a state where the antenna switching switch can be switched to the connection of the second input terminal, when the analog wave is received by the third antenna, the input terminal (the input terminal n) connected to the second antenna is not used.

Accordingly, when the input terminal which may have an unused state is provided separately from the antenna switching switch, space-saving is impeded, causing difficulties in decreasing the size of the image display apparatus, and the manufacturing cost is increased.

It is desirable to reduce size and the manufacturing cost in the reception device according to an embodiment of the present disclosure.

### SUMMARY

According to an embodiment of the present disclosure, there is provided a reception device including a first antenna and a second antenna that receive the same kind of electric wave; a third antenna that receives a different kind of electric waves from the electric wave of the first antenna and the second antenna; an antenna switching switch that switches a first input mode of inputting the electric waves received by the first antenna and the second antenna and a second input mode of inputting the electric wave received by the third antenna; a first tuner circuit that is connected to the antenna switching switch and receives the electric wave in each of the first input mode and the second input mode; and a second tuner circuit that is connected to the antenna switching switch and receives the electric wave in the first input mode, wherein diversity reception for the first antenna and the second antenna is performed on the basis of signals output from the first tuner circuit and the second tuner circuit in the first input mode, and wherein a signal is output from the first tuner circuit in the second input mode.

Accordingly, in the reception device, the switching of the first input mode and the second input mode in the antenna switching switch is performed to receive a different kind of electric waves.

In the reception device, the antenna switching switch may be provided with a first input terminal and a second input terminal, the electric wave received by the first antenna may be input to the first input terminal, the electric waves received by the second antenna and the third antenna may be input to the second input terminal.

The antenna switching switch is provided with the first input terminal and the second input terminal, the electric wave received by the first antenna is input to the first input terminal, the electric waves received by the second antenna and the third antenna are input to the second input terminal, and thus the antenna switching switch corresponding to the diversity reception is configured with the simple configuration.

In the reception device, the antenna switching switch may be provided with a first output terminal connected to the first tuner circuit and a second output terminal connected to the second tuner circuit, in the first input mode, the first input terminal may be connected to the first output terminal, the second input terminal may be connected to the second output terminal, in the second input mode, the connection between the first input terminal and the first output terminal and the connection between the second input terminal and the second output terminal are cut off, and the second input terminal may be connected to the first output terminal.

In the first input mode, the first input terminal is connected to the first output terminal, the second input terminal is connected to the second output terminal, in the second input mode, the second input terminal is connected to the first output terminal, and thus a desired electric wave is received in the first input mode and the second input mode by the simple switching of the connection states.

In the reception device, the first antenna and the second antenna may receive digital waves, and the third antenna may receive an analog wave.

The first antenna and the second antenna may receive the digital waves, the third antenna receives the analog wave, and thus the diversity reception is performed with respect to digital broadcasting.

In the reception device, a high frequency amplifier may be provided on a transmission path of the digital wave.

The high frequency amplifier is provided on the transmission path of the digital wave, and thus each of the digital waves received by the first antenna and the second antenna is input to the high frequency amplifier.

According to another embodiment of the present disclosure, there is provided an image display device including: a reception device that receives a plurality of electric waves; and a display that displays an image according to image signals output on the basis of the electric waves received by the reception device, wherein the reception device includes a first antenna and a second antenna that perform diversity reception to receive the same kind of electric wave, a third antenna that receives a different kind of electric waves from the electric wave of the first antenna and the second antenna, an antenna switching switch that switches a first input mode of inputting the electric waves received by the first antenna and the second antenna and a second input mode of inputting the electric wave received by the third antenna, a first tuner circuit that is connected to the antenna switching switch and receives the electric wave in each of the first input mode and the second input mode, and a second tuner circuit that is connected to the antenna switching switch and receives the electric wave in the first input mode, wherein diversity reception for the first antenna and the second antenna is performed on the basis of signals output from the first tuner circuit and the second tuner circuit in the first input mode, and wherein a signal is output from the first tuner circuit in the second input mode.

Accordingly, in the image display apparatus, the first input mode and the second input mode in the antenna switching switch are switched to receive a different kind of electric waves.

A reception device according to the present disclosure includes: a first antenna and a second antenna that receive the same kind of electric wave; a third antenna that receives a different kind of electric waves from the electric wave of the first antenna and the second antenna; an antenna switching switch that switches a first input mode of inputting the electric waves received by the first antenna and the second antenna and a second input mode of inputting the electric wave received by the third antenna; a first tuner circuit that is connected to the antenna switching switch and receives the electric wave in each of the first input mode and the second input mode; and a second tuner circuit that is connected to the antenna switching switch and receives the electric wave in the first input mode, wherein diversity reception for the first antenna and the second antenna is performed on the basis of signals output from the first tuner circuit and the second tuner circuit in the first input mode, and wherein a signal is output from the first tuner circuit in the second input mode.

Accordingly, it is not necessary to provide an input terminal only for inputting the electric wave received by the third antenna, and thus it is possible to reduce the size and the manufacturing cost of the reception device.

In the reception device, the antenna switching switch is provided with a first input terminal and a second input terminal, the electric wave received by the first antenna is input to the first input terminal, and the electric waves received by the second antenna and the third antenna are input to the second input terminal.

Accordingly, it is possible to configure the antenna switching switch corresponding to the diversity reception by the simple configuration, and thus it is possible to further reduce the size and the manufacturing cost of the reception device.

In the reception device, the antenna switching switch is provided with a first output terminal connected to the first tuner circuit and a second output terminal connected to the second tuner circuit, in the first input mode, the first input terminal is connected to the first output terminal, the second input terminal is connected to the second output terminal, and in the second input mode, the connection between the first input terminal and the first output terminal and the connection between the second input terminal and the second output terminal are cut off, and the second input terminal is connected to the first output terminal.

Accordingly, it is possible to receive a desired electric wave in the first input mode and the second input mode by the simple switching of the connection state, and it is possible to reduce the size and the manufacturing cost by the simplification of the structure.

In the reception device, the first antenna and the second antenna may receive digital waves, and the third antenna receives an analog wave.

Accordingly, it is possible to reproduce the satisfactory output signal by the diversity reception in the digital broadcasting.

In the reception device, a high frequency amplifier is provided on a transmission path of the digital wave.

Accordingly, it is possible to improve reception sensitivity of the digital wave.

An image display device according to the present disclosure includes: a reception device that receives a plurality of electric waves; and a display that displays an image according to image signals output on the basis of the electric waves received by the reception device, wherein the reception device includes a first antenna and a second antenna that perform diversity reception to receive the same kind of electric wave, a third antenna that receives a different kind of electric waves from the electric wave of the first antenna and the second antenna, an antenna switching switch that switches a first input mode of inputting the electric waves received by the first antenna and the second antenna and a second input mode of inputting the electric wave received by the third antenna, a first tuner circuit that is connected to the antenna switching switch and receives the electric wave in each of the first input mode and the second input mode, and a second tuner circuit that is connected to the antenna switching switch and receives the electric wave in the first input mode, wherein diversity reception for the first antenna and the second antenna is performed on the basis of signals output from the first tuner circuit and the second tuner circuit in the first input mode, and wherein a signal is output from the first tuner circuit in the second input mode.

Accordingly, it is not necessary to provide an input terminal only for inputting the electric wave received by the third antenna, and thus it is possible to reduce the size and the manufacturing cost of the reception device.

### BRIEF DESCRIPTION OF THE DRAWINGS

FIG. 1 is a diagram illustrating a reception device and an image display apparatus of the present disclosure with

FIG. 2 to FIG. 5, and is a schematic diagram illustrating the image display apparatus.

FIG. 2 is a diagram illustrating a configuration of the reception device representing a state where a first input mode is set.

FIG. 3 is a diagram illustrating a configuration of the reception device representing a state where a second input mode is set.

FIG. 4 is a schematic diagram illustrating a configuration of a reception device of the related art in which a diversity reception method is employed.

FIG. 5 is a schematic diagram illustrating a configuration of a reception device in which it is possible to receive a digital wave and an analog wave and a diversity reception method is employed for reception of a digital wave.

### DETAILED DESCRIPTION OF EMBODIMENTS

Hereinafter, a reception device and an image display apparatus according to an embodiment of the present disclosure will be described with reference to the accompanying drawings.

In the preferred embodiment to be described hereinafter, the image display apparatus of the present disclosure is applied to a television, and the reception device of the present disclosure is applied to a reception device provided in the television.

However, the application scope of the present disclosure is not limited to the television and the reception device provided therein. The image display apparatus of the present disclosure may be applied to various image display apparatuses that display an image on a display of, for example, a mobile terminal device, a personal computer, or the like, and the reception device of the present disclosure may be broadly applied to a reception device provided in such various image display apparatuses.

### Schematic Configuration of Image Display Apparatus

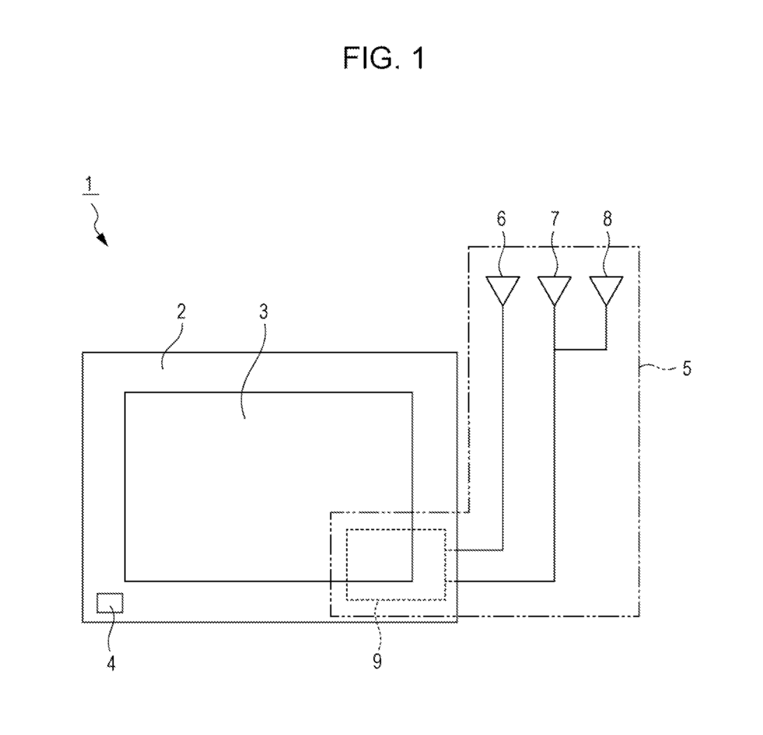

First, a schematic configuration of an image display apparatus will be described (see FIG. 1).

An image display apparatus 1 has a case 2, and a display 3 is disposed on a front face portion of the case 2. The display 3 may be, for example, a liquid crystal display, a plasma display, an organic EL (Electro Luminescence) display.

An infrared reception unit 4 to which an operation signal based on an operation of a remote control device or the like is input is provided on the front face of the case 2. An RF (Radio Frequency) signal input terminal (not shown) is provided on the lateral face or the rear face of the case 2.

The image display apparatus 1 is provided with a reception device 5 including the RF signal input terminal.

The reception device 5 includes a first antenna 6, a second antenna 7, and a third antenna 8, which are connected to the RF signal input terminal through a transmission cable, and a circuit unit 9 which is disposed in the case 2.

### Configuration of Reception Device

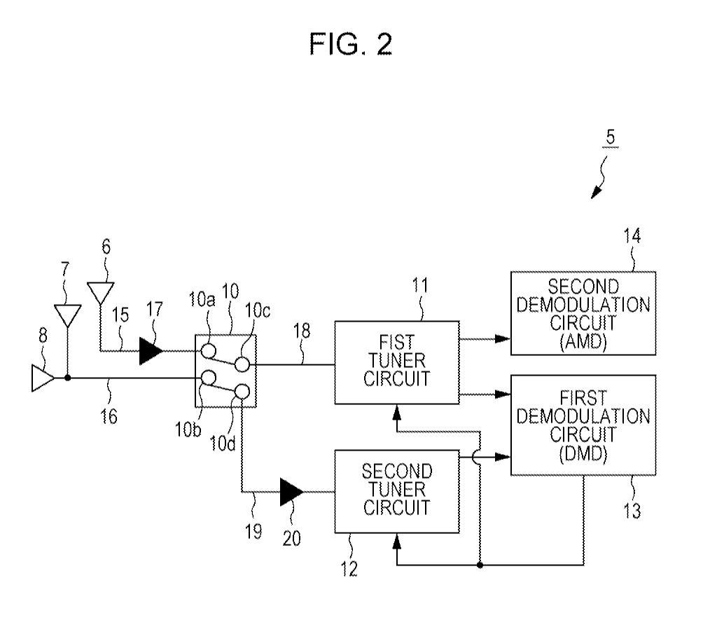

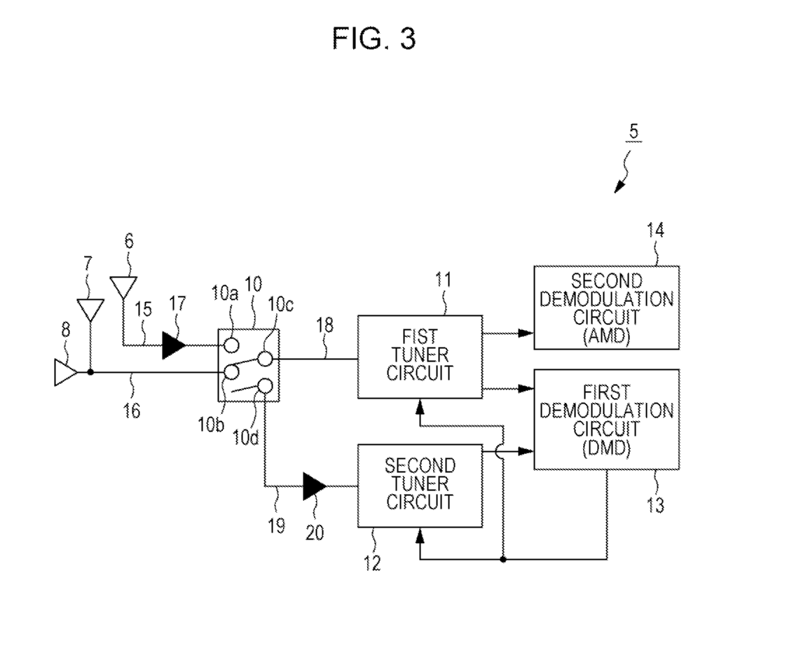

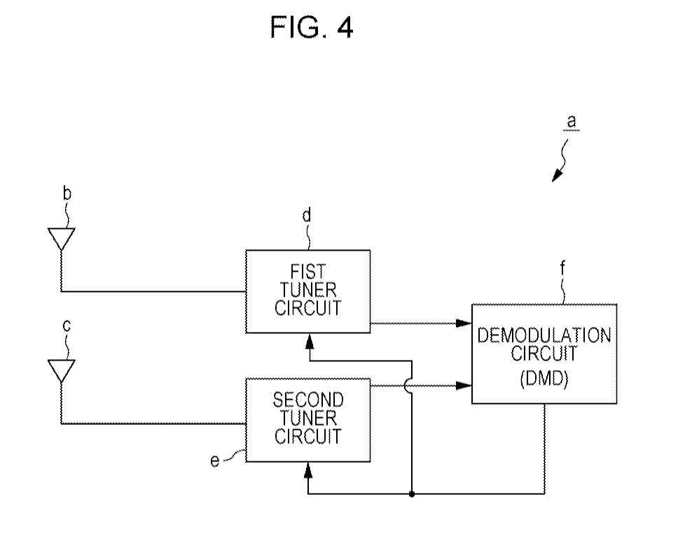

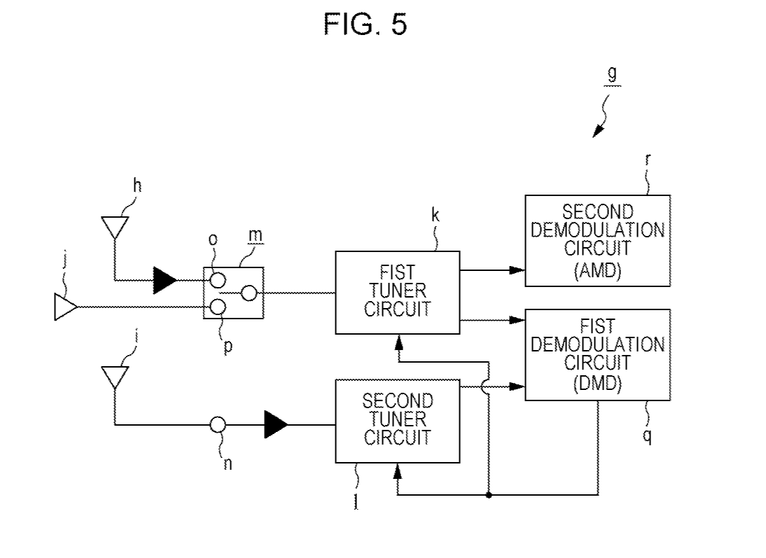

Next, a specific configuration of the reception device 5 will be described (see FIG. 2 and FIG. 3).

The reception device 5 includes a first antenna 6, a second antenna 7, a third antenna 8, an antenna switching switch 10, a first tuner circuit 11, a second tuner circuit 12, a first demodulation circuit 13, and a second demodulation circuit 14. The antenna switching switch 10, the first tuner circuit 11, the second tuner circuit 12, the first demodulation circuit 13, and the second demodulation circuit 14 are provided in the circuit unit 9.

The first antenna 6 and the second antenna 7 may receive the same kind of electric wave, for example, digital waves, and the third antenna 8 receives an electric wave different from the electric waves received by the first antenna 6 and the second antenna 7, for example, an analog wave.

The first antenna 6 is connected to the antenna switching switch 10 through a first transmission path 15, and the second antenna 7 and the third antenna 8 are connected to the antenna switching switch 10 through the second transmission path 16.

The antenna switching switch 10 includes a first input terminal 10a, a second input terminal 10b, a first output terminal 10c, and a second output terminal 10d. The first input terminal 10a is connected to the first transmission path 15, and the second input terminal 10b is connected to the second transmission path 16. Accordingly, the second antenna 7 and the third antenna 8 share the second input terminal 10b with respect to the connection to the antenna switching switch 10.

A first high frequency amplifier (LNA: Low Noise Amplifier) 17 is provided on the first transmission path 15. The first high frequency amplifier 17 has a function of improving reception sensitivity of the transmitted electric waves.

In the reception device 5, in the antenna switching switch 10, the first input terminal 10a is connected to the first output terminal 10c, and the second input terminal 10b is connected to the second output terminal 10d, thereby setting the first input mode (see FIG. 2). In addition, the connection between the first input terminal 10a and the first output terminal 10c, and the connection between the second input terminal 10b and the second output terminal 10d are cut off, the second input terminal 10b is connected to the first output terminal 10c, thereby setting the second input mode (see FIG. 3).

The first tuner circuit 11 and the second tuner circuit 12 have a function of tuning for extracting a desired RF signal and frequency conversion for outputting a digital signal or an analog signal as a video signal and a sound signal to the first demodulation circuit 13 and the second demodulation circuit 14.

The first tuner circuit 11 is connected to the first output terminal 10c of the antenna switching switch 10 through the third transmission path 18, and the second tuner circuit 12 is connected to the second output terminal 10d of the antenna switching switch 10 through a fourth transmission path 19. A second high frequency amplifier (LNA: Low Noise Amplifier) 20 is provided on the fourth transmission path 19. The second high frequency amplifier 20 has a function of improving reception sensitivity of the transmitted electric waves.

The first demodulation circuit 13 is a digital demodulation device (DMD), and a digital signal is input from the first tuner circuit 11 and the second tuner circuit 12 to the first demodulation circuit 13.

The second demodulation circuit 14 is an analog demodulation device (AMD), and an analog signal is input from the first tuner circuit 11 to the second demodulation circuit 14.

### Operation of Reception Device

Next, an operation of the reception device 5 will be described (see FIG. 2 and FIG. 3)

In the image display apparatus 1, the input mode is switched with respect to the antenna switching switch 10 of the reception device 5. The switching of the input mode with respect to the antenna switching switch 10 is performed, for example, according to the kind or the like of broadcasting selected by a user. For example, when the user selects terrestrial digital broadcasting by an operation of a remote control device or the like, the first input terminal 10a is connected to the first output terminal 10c, and the second input terminal 10b is connected to the second output terminal 10d, thereby setting the first input mode (see FIG. 2). In addition, when the user selects cable television broadcasting by an operation of a remote control device or the like, the second input terminal 10b is connected to the first output terminal 10c, thereby setting the second input mode (see FIG. 3).

In the state where the antenna switching switch 10 is switched and the first input mode is set (see FIG. 2), when the digital waves received by the first antenna 6 and the second antenna 7 are transmitted to the first tuner circuit 11 and the second tuner circuit 12 through the first input terminal 10a and the second input terminal 10b of the antenna switching switch 10, respectively, tuning and frequency conversion are performed in the first tuner circuit 11 and the second tuner circuit 12. The first demodulation circuit 13 controls the first tuner circuit 11 and the second tuner circuit 12 to perform ordinary diversity reception, to display an image on the display 3 and to output a sound on the basis of digital signals (an image signal and a sound signal) generated by the electric wave in a satisfactory reception state between the first tuner circuit 11 and the second tuner circuit 12.

Meanwhile, in the state where the antenna switching switch 10 is switched and the second input mode is set (see FIG. 3), the analog wave received by the third antenna 8 is transmitted to the first tuner circuit 11 through the second input terminal 10b, and the analog signal is input from the first tuner circuit 11 to the second demodulation circuit 14, thereby displaying an image on the display 3 and outputting a sound.

In the above description, the example in which the electric wave received by the third antenna 8 is the analog wave is described, but the electric wave received by the third antenna 8 may be, for example, a different kind of digital waves from the electric wave of the digital waves received by the first antenna 6 and the second antenna 7. For example, one kind of digital waves for terrestrial broadcasting or cable television broadcasting may be received by the first antenna 6 and the second antenna 7, and the other digital wave for terrestrial broadcasting or cable television broadcasting may be received by the third antenna 8.

In this case, the first demodulation circuit 13 has a function of demodulating two kinds of digital waves, and both digital waves of one digital wave received by the first antenna 6 and the second antenna 7 and the other digital wave received by the third antenna 8 are input to the first demodulation circuit 13 in the first input mode and the second input mode.

When a different kind of digital waves are input to the first demodulation circuit 13, for example, the demodulation function is switched on the basis of the operation of the user, and the demodulation process is performed on each input digital wave with different kinds.

Overview

As described above, in the image display apparatus 1, the first antenna 6, the second antenna 7, and the third antenna 8 are connected to the antenna switching switch 10, the antenna switching switch 10 is switched to set the first input mode or the second input mode, the diversity reception is performed, and the image is displayed on the basis of a different kind of electric waves.

Accordingly, it is not necessary to provide an input terminal (an RF signal input terminal) only for inputting the electric wave received by the third antenna 8, and thus it is possible to reduce the size and the manufacturing cost in the image display apparatus 1 and the reception device 5 provided in the image display apparatus 1.

In addition, the antenna switching switch 10 is provided with the first input terminal 10a and the second input terminal 10b, the electric wave received by the first antenna 6 is input to the first input terminal 10a, and the electric waves received by the second antenna 7 and the third antenna 8 are input to the second input terminal 10b.

Accordingly, it is possible to configure the antenna switching switch 10 corresponding to the diversity reception by the simple configuration, and it is possible to further reduce the size and the manufacturing cost in the image display apparatus 1 and the reception device 5 corresponding to the image display apparatus 1.

In addition, the antenna switching switch 10 is provided with the first output terminal 10c connected to the first tuner circuit 11 and the second output terminal 10d connected to the second tuner circuit 12, in the first input mode, the first input terminal 10a is connected to the first output terminal 10c, and the second input terminal 10b is connected to the second output terminal 10b, and in the second input mode, the second input terminal 10b is connected to the first output terminal 10c.

Accordingly, it is possible to receive a desired electric wave in the first input mode and the second input mode by the simple switching of the connection state, and it is possible to reduce the size and the manufacturing cost by the simplification of the structure.

In addition, the first antenna 6 and the second antenna 7 receive the digital wave, and the third antenna 8 receives the analog wave. Accordingly, it is possible to perform reproduction of the satisfactory output signal on the digital broadcasting by the diversity reception.

In addition, the first high frequency amplifier 17 and the second high frequency amplifier 20 are provided on the first transmission path 15 and the fourth transmission path 19 that are transmission paths of the digital waves, and thus it is possible to improve reception sensitivity of the digital wave.

### Present Technology

The present technology may have the following configurations.

(1) A reception device including: a first antenna and a second antenna that receive the same kind of electric waves; a third antenna that receives a different kind of electric waves from that of the first antenna and the second antenna; an antenna switching switch that switches a first input mode of inputting the electric waves received by the first antenna and the second antenna and a second input mode of inputting the electric wave received by the third antenna; a first tuner circuit that is connected to the antenna switching switch and receives the electric wave in each of the first input mode and the second input mode; and a second tuner circuit that is connected to the antenna switching switch and receives the electric wave in the first input mode, wherein diversity reception for the first antenna and the second antenna is performed on the basis of signals output from the first tuner circuit and the second tuner circuit in the first input mode, and wherein a signal is output from the first tuner circuit in the second input mode.

(2) The reception device according to the above (1), wherein the antenna switching switch is provided with a first input terminal and a second input terminal, wherein the electric wave received by the first antenna is input to the first input terminal, and wherein the electric waves received by the second antenna and the third antenna are input to the second input terminal.

(3) The reception device according to the above (2), wherein the antenna switching switch is provided with a first output terminal connected to the first tuner circuit and a second output terminal connected to the second tuner circuit, wherein in the first input mode, the first input terminal is connected to the first output terminal, and the second input terminal is connected to the second output terminal, and wherein in the second input mode, the connection between the first input terminal and the first output terminal and the connection between the second input terminal and the second output terminal are cut off, and the second input terminal is connected to the first output terminal.

(4) The reception device according to any one of the above (1) to (3), wherein the first antenna and the second antenna receive a digital wave, and wherein the third antenna receives an analog wave.

(5) The reception device according to the above (4), wherein a high frequency amplifier is provided on a transmission path of the digital wave.

(6) An image display device including: a reception device that receives a plurality of electric waves; and a display that displays an image according to image signals output on the basis of the electric waves received by the reception device, wherein the reception device includes a first antenna and a second antenna that perform diversity reception to receive the same kind of electric wave, a third antenna that receives a different kind of electric waves from the electric wave of the first antenna and the second antenna, an antenna switching switch that switches a first input mode of inputting the electric waves received by the first antenna and the second antenna and a second input mode of inputting the electric wave received by the third antenna, a first tuner circuit that is connected to the antenna switching switch and receives the electric wave in each of the first input mode and the second input mode, and a second tuner circuit that is connected to the antenna switching switch and receives the electric wave in the first input mode, wherein diversity reception for the first antenna and the second antenna is performed on the basis of signals output from the first tuner circuit and the second tuner circuit in the first input mode, and wherein a signal is output from the first tuner circuit in the second input mode.

The present disclosure contains subject matter related to that disclosed in Japanese Priority Patent Application JP 2011-283089 filed in the Japan Patent Office on Dec. 26, 2011, the entire contents of which are hereby incorporated by reference.

The specific shapes and structure of the units described in the preferred embodiment of the present disclosure are merely examples of embodiments when performing the present technology, and the technical scope of the present disclosure should not be considered to be limited thereby.

What is claimed is:

1. A reception device comprising:
a first antenna and a second antenna that receive the same kind of electric wave;
a third antenna that receives a different kind of electric waves from the electric wave of the first antenna and the second antenna;
an antenna switching switch that switches a first input mode of inputting the electric waves received by the first antenna and the second antenna and a second input mode of inputting the electric wave received by the third antenna;
a first tuner circuit that is connected to the antenna switching switch and receives the electric wave in each of the first input mode and the second input mode; and
a second tuner circuit that is connected to the antenna switching switch and receives the electric wave in the first input mode,
wherein diversity reception for the first antenna and the second antenna is performed on the basis of signals output from the first tuner circuit and the second tuner circuit in the first input mode, and
wherein a signal is output from the first tuner circuit in the second input mode.

2. The reception device according to claim 1, wherein the antenna switching switch is provided with a first input terminal and a second input terminal,
wherein the electric wave received by the first antenna is input to the first input terminal, and
wherein the electric waves received by the second antenna and the third antenna are input to the second input terminal.

3. The reception device according to claim 2, wherein the antenna switching switch is provided with a first output terminal connected to the first tuner circuit and a second output terminal connected to the second tuner circuit,
wherein in the first input mode, the first input terminal is connected to the first output terminal, and the second input terminal is connected to the second output terminal, and
wherein in the second input mode, the connection between the first input terminal and the first output terminal and the connection between the second input terminal and the second output terminal are cut off, and the second input terminal is connected to the first output terminal.

4. The reception device according to claim 1, wherein the first antenna and the second antenna receive digital waves, and
wherein the third antenna receives an analog wave.

5. The reception device according to claim 4, wherein a high frequency amplifier is provided on a transmission path of the digital wave.

6. An image display device comprising:
a reception device that receives a plurality of electric waves; and
a display that displays an image according to image signals output on the basis of the electric waves received by the reception device,
wherein the reception device includes
a first antenna and a second antenna that perform diversity reception to receive the same kind of electric wave,
a third antenna that receives a different kind of electric waves from the electric wave of the first antenna and the second antenna,
an antenna switching switch that switches a first input mode of inputting the electric waves received by the first antenna and the second antenna and a second input mode of inputting the electric wave received by the third antenna,
a first tuner circuit that is connected to the antenna switching switch and receives the electric wave in each of the first input mode and the second input mode, and
a second tuner circuit that is connected to the antenna switching switch and receives the electric wave in the first input mode,
wherein diversity reception for the first antenna and the second antenna is performed on the basis of signals output from the first tuner circuit and the second tuner circuit in the first input mode, and
wherein a signal is output from the first tuner circuit in the second input mode.
